(19) United States
(12) Patent Application Publication
(10) Pub. No.: US 2010/0153059 A1
(43) Pub. Date: Jun. 17, 2010

(54) APPARATUS AND METHOD FOR MEASURING THE POSITIONS OF MARKS ON A MASK

(76) Inventors: Gerd Klose, Oberkochen (DE); Michael Arnz, Oberkochen (DE); Albrecht Hof, Aalen (DE); Helmut Krause, Aalen (DE); Ulrich Stroessner, Jena (DE); Matthias Manger, Aalen-Unterkochen (DE); Uwe Schellhorn, Aalen (DE); Karl-Heinz Bechstein, Ossmannstedt (DE)

Correspondence Address: FISH & RICHARDSON PC, P.O. BOX 1022, MINNEAPOLIS, MN, 55440-1022, US

(21) Appl. No.: 12/594,373

(22) PCT Filed: Mar. 11, 2008
(86) PCT No.: PCT/EP08/01936

§ 371 Date: Feb. 26, 2010

Related U.S. Application Data
(60) Provisional application No. 60/910,137, filed on Apr. 4, 2007.

(51) Int. Cl. G06F 15/00; G01B 21/20

(52) U.S. Cl. 702/150

(57) ABSTRACT

An apparatus for measuring the positions of marks on a mask is provided, said apparatus comprising a mask holder for holding the mask, a recording unit for recording the marks of the mask held by the mask holder, an actuating module for moving the mask holder and the recording unit relative to each other, and an evaluating module, which numerically calculates the gravity-induced sagging of the mask in the mask holder and determines the positions of the marks on the mask, based on the calculated sagging, the recordings made by the recording unit and the relative movement between the mask holder and the recording unit, wherein, prior to calculating said sagging, the present position of the mask in the mask holder is determined and is taken into consideration in said numerical calculation, and/or the geometrical dimensions of the mask are taken into consideration in said numerical calculation of sagging.

The invention relates to an apparatus and a method for measuring the positions of marks on a mask.

One problem of such an apparatus is that the mask sags, due to its own weight, when it is held, for example, on a 3-point support. In a mask substantially having a cuboid shape and a width of 152 mm, a length of 152 mm as well as a height of 6.35 mm, such sagging (depending on how the three points of support are arranged) leads to a shift of the pattern on the mask (i.e. of the pattern used for exposure in semiconductor production) of approximately 600-800 nm in the z direction (i.e. perpendicular to the mask plane) and of approximately 60-80 nm in the x-y direction (i.e. within the mask's plane). In order to correct this shift of the pattern, the sagging of the mask has frequently been simulated by a finite elements model calculation and then taken into consideration in evaluating the optical measurement. Meanwhile, accuracies of measurement of less than 1 nm in the x-y direction are demanded and it has turned out that the achievable accuracy is then no longer sufficient.

In view of the above, it is an object of the invention to provide an apparatus for measuring the positions of marks on a mask, said apparatus allowing to achieve the desired accuracy of measurement in the mask plane. Further, it is intended to provide a corresponding method for measuring the positions of marks on a mask.

The object is achieved by an apparatus for measuring the positions of marks on a mask, said apparatus comprising a mask holder for holding the mask, a recording unit for recording the marks of the mask held by the mask holder, an actuating module for moving the mask holder and the recording unit relative to each other, and an evaluating module, which numerically calculates the gravity-induced sagging of the mask in the mask holder and determines the positions of the marks on the mask, based on the calculated sagging, the recordings made by the recording unit and the relative movement between the mask holder and the recording unit, wherein

a) prior to calculating said sagging, the present position of the mask in the mask holder is determined and is taken into consideration in said numerical calculation, and/or

b) the geometrical dimensions of the mask are taken into consideration in said numerical calculation of sagging.

Considering the present, i.e. actual, position of the mask in the mask holder allows to achieve sufficient accuracy in the calculation of sagging. This is because it has turned out that even minimal changes in the position of the mask on the mask holder lead to changes in sagging.

The consideration of the geometrical dimensions of the mask leads to a further increase in accuracy when calculating the sagging of the mask.

The apparatus according to the invention can be provided such that it measures at least one geometrical dimension of the mask (e.g. when held by the mask holder). Of course, the apparatus according to the invention can also measure several or all (necessary) geometrical dimensions of the mask. As an alternative, it is possible that one, several or all (necessary) geometrical dimensions are measured by a separate measurement apparatus and are then supplied to the apparatus according to the invention, so that the latter can take the geometrical dimensions into consideration in the calculation of sagging.

The mask holder of the apparatus according to the invention can be provided as a 3-point support. However, any other type of mask holder is also possible.

In particular, the apparatus can comprise a first measuring module which measures the position of the mask in the mask holder. This ensures that the actually present position of the mask in the mask holder is taken into consideration in every calculation of sagging, which leads to very good results of measurement.

The calculation of sagging is carried out, in particular, as a finite elements calculation. However, any other kind of numerical modeling is also possible.

The first measuring module can measure at least the position of a mask edge relative to the mask holder. Such measurement of the mask edge is relatively easy to carry out with the desired accuracy.

Of course, it is also possible to measure the position relative to the mask holder for several mask edges using the first measuring module.

The mask can be provided substantially as a cuboid, in which case the measured length, width and height of the cuboid will then be taken into consideration in the calculation of sagging.

Further, it is possible for the apparatus to comprise a second measuring module which measures the weight of the mask and two of the cuboid's three dimensions of length, width and height, and calculates the third dimension on the basis of the two measured dimensions and of the measured weight. It is particularly advantageous to measure length and width. This can be done, for example, using a conventional microscope.

The measurement of the geometrical dimensions and/or of the weight can be carried out internally or externally of the apparatus for measuring the positions of marks on a mask.

The apparatus can further include a handling module which positions the mask with high accuracy in a predetermined position in order to determine the position of the mask in the mask holder.

The handling module can carry out positioning of the mask in the mask holder with feedback control, for example. For this purpose, optical and/or mechanical measurements can be carried out. Also, mechanical sensing devices can be used to predetermine the desired position (target position) in the mask holder.

If the mask is transparent, it is possible to optically measure the thickness of the mask. In particular, the recording unit can be employed for thickness measurement. The thickness is preferably measured at the points of support of the mask holder.

The object is further achieved by a method for measuring the positions of marks on a mask, wherein

a) the mask is positioned on a mask holder,

b) the marks of the mask held by the mask holder are recorded, and

c) the gravity-induced sagging of the mask in the mask holder is numerically calculated, and the positions of the mask are determined on the basis of the calculated sagging as well as of the recordings, wherein

d) the geometrical dimensions of the mask are taken into consideration in the calculation of sagging, and/or the present position of the mask in the mask holder is determined prior to said calculation of sagging and is taken into consideration in said numerical calculation.

This method makes it possible to calculate the sagging of the mask with high accuracy and to thereby carry out a position determination with the required accuracy within the mask plane.

In order to carry out recording of the marks, the method preferably comprises carrying out a relative movement between the mask and the corresponding recording unit. In particular, the mask can be moved relative to the recording unit. This relative movement is taken into consideration when determining the positions of the marks.

The mask holder can be provided as a 3-point support. In particular, the exact positions of the individual supports of the 3-point supports relative to a reference point of the mask holder can be measured in a standardizing step.

In particular, the position of the mask (e.g. on the basis of one or several points of the mask) in the mask holder can be measured. This measurement may, of course, be carried out relative to the reference point.

At least the position of a mask edge relative to the mask holder can be measured. The position of the mask in the mask holder can be derived therefrom, if the geometry of the mask is known in advance.

The geometrical dimensions taken into consideration in the calculation of sagging can be determined by measurements. In particular, these measurements can be carried out on the mask positioned on the mask holder. However, it is also possible to carry out measurement of the mask before it is positioned on the mask holder. For example, it is possible to measure the weight of the mask and to derive a geometrical dimension from the measured weight.

For example, the mask can be provided substantially as a cuboid, so that the measured length, width and height of the cuboid are taken into consideration in the calculation of sagging.

It is further possible, if the mask is provided as a cuboid, to measure the weight of the mask and two of the cuboid's three dimensions of length, width and height, and to calculate the third dimension on the basis of the two measured dimensions and of the measured weight.

The mask can be positioned with high accuracy in a predetermined position in the mask holder in order to determine the position of the mask in the mask holder. This can be effected, in particular, with feedback control.

It will be appreciated that the aforementioned features and those yet to be explained below can be used not only in the combinations indicated, but also in other combinations or alone, without departing from the scope of the invention.

The invention will be explained in more detail below, by way of example and with reference to the enclosed drawings, which also disclose features essential to the invention and wherein:

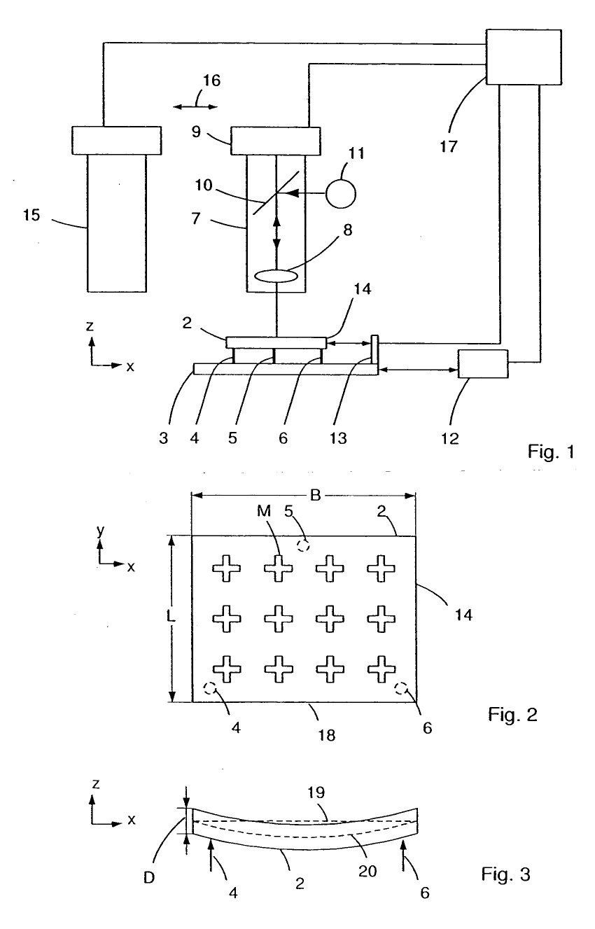

FIG. 1 shows a schematic view of the apparatus for measuring the positions of marks on a mask;

FIG. 2 shows a top view of the mask 2 to be measured, and

FIG. 3 shows a schematic view explaining the sagging of the mask 2 held in the mask holder 3.

In the embodiment shown in FIG. 1, the apparatus 1 for measuring the positions of marks M on a mask 2 comprises a mask holder 3 for holding the mask 2.

The mask holder 3 is provided as a 3-point support and comprises the supports 4, 5 and 6 schematically shown in FIG. 1.

FIG. 2 schematically shows the mask 2 in a top view, wherein the marks M are shown schematically and not to scale. The positions at which the mask 2 is supported on the supports 4-6 by its lower surface are each shown in FIG. 2 as dashed circular lines.

The apparatus 1 for measuring the positions of marks M on the mask 2 comprises a recording unit 7, of which a measuring objective 8 and a detector 9 are schematically shown here. The recording unit 7 further comprises a beam splitter 10 as well as a source of illumination 11, so that the marks M can be recorded using incident-light illumination.

The mask holder 3 can be moved by an actuating module 12 relative to the measuring objective 8 in a plane perpendicular to the drawing plane. Using the actuating module 12, the mask holder 3 and, thus, the mask 2 can each be positioned such that the recording unit 7 can record one of the marks M with great magnification.

The mask holder 3 has attached to it a first measuring module 13 allowing to measure the position and orientation of the edge 14 of the mask 2 relative to the supports 4-6.

The apparatus 1 further includes a second measuring module 15, which can be positioned above the mask 2, instead of the recording unit 7, as indicated by the double arrow 16. Using the second measuring module 15, the dimensions can be measured in a top view of the mask (i.e. length and width).

The recording unit 7, the second measuring module 15, the first measuring module 13 as well as the actuating module 12 are connected to an evaluating module 17, which determines the positions of the marks M of the mask 2. This determination is based on the recordings and on the relative movement between the recording unit 7 and the mask 2. Further, the gravity-induced sagging of the mask, which is shown in a schematic and greatly exaggerated manner in FIG. 3 for the front edge 18, is modeled by a finite elements calculation (in FIG. 3, the dashed line 19 is the zero locus at zero gravity and the dashed line 20 is the zero locus for the sagging induced by gravity). This calculation takes the position and orientation, measured by the first measuring module 13, of the edge 14 or of the mask 2, respectively, relative to the supports 4, 5 and 6 into consideration. Thus, the sagging actually present is mathematically modeled with extreme accuracy, as a result of which the positions of the marks M on the mask 2 are determined with very high accuracy.

In addition to the position of the mask 2 on the supports 4-6, the geometrical dimensions of the mask 2 can further be taken into consideration. The thickness D of the mask 2 can be measured by the first measuring module 13. The length L and the width B (top view) of the mask 2 can be measured by the second measuring module 15, which is positioned for said measurement in a position above the held mask 2. The consideration of the measured geometrical dimensions of the mask 2 in the calculation of sagging leads to higher accuracy.

The measurement of the geometrical dimensions need not be carried out in the apparatus 1 for measuring the positions of marks M on the mask 2. It is possible for the mask 2 to be measured before it is placed in the apparatus 1. However, the measurement of the position of the mask 2 relative to the supports 4-6 has to be carried out in the apparatus 1 itself.

The geometrical dimensions can also be determined such that, for example, only the length L and the width B are optically measured. Further, the mask 2 is weighed, so that the thickness of the mask 2 can be calculated for a known material.

In a standardizing step, the positions of the supports 4, 5 and 6 without the mask 2 can be measured with high accuracy, e.g. relative to the first measuring module 13. Then, the exact positions at which the mask 2 is supported on the supports 4-6 can be determined by measuring the position of the mask 2 in the mask holder 3.

Instead of measuring the position of the mask 2 relative to the supports 4-6, it is also possible to position the mask 2 with high accuracy on the supports 4-6. For this purpose, a handling module (not shown), which is part of the apparatus 1, can position the mask in the same orientation on the supports 4-6 at all times. Said positioning can be preferably carried out with feedback control. It is possible, for example, to optically measure the position at the same time. Further, mechanical switches or sensing device can be used to predetermine or set, respectively, the desired orientation on the supports 4-6.

1. An apparatus for measuring the positions of marks on a mask, said apparatus comprising
a mask holder for holding the mask,
a recording unit for recording the marks of the mask held by the mask holder,
an actuating module for moving the mask holder and the recording unit relative to each other, and
an evaluating module, which numerically calculates the gravity-induced sagging of the mask in the mask holder, and determines the positions of the marks on the mask, based on the calculated sagging, the recordings made by the recording unit and the relative movement between the mask holder and the recording unit,
wherein, prior to calculating said sagging, the present position of the mask in the mask holder is determined and is taken into consideration in said numerical calculation, and/or the geometrical dimensions of the mask are taken into consideration in said numerical calculation of sagging.

2. The apparatus as claimed in claim 1, wherein the mask holder is provided as a 3-point support.

3. The apparatus as claimed in claim 1, comprising a first measuring module, which measures the position of the mask in the mask holder.

4. The apparatus as claimed in claim 3, wherein the first measuring module measures at least the position of a mask edge relative to the mask holder.

5. The apparatus as claimed in claim 1, wherein the mask is provided substantially as a cuboid and the measured length, width and height of the cuboid are taken into consideration in the calculation of sagging.

6. The apparatus as claimed in claim 1, wherein the mask is provided substantially as a cuboid and the apparatus comprises a second measuring module, which measures the weight of the mask and two of the cuboid's three dimensions of length, width and height and calculates the third dimension on the basis of the two measured dimensions and of the measured weight.

7. The apparatus as claimed in claim 1, comprising a handling module, which positions the mask in a predetermined position in order to determine the position of the mask in the mask holder.

8. The apparatus as claimed in claim 7, wherein the handling module carries out said positioning of the mask in the mask holder.

9. A method for measuring the positions of marks on a mask, wherein
a) the mask is positioned on a mask holder,
b) the marks of the mask held by the mask holder are recorded and
c) the gravity-induced sagging of the mask in the mask holder is numerically calculated, and the positions of the marks on the mask are determined on the basis of the calculated sagging as well as of the recordings,
wherein
d) the geometrical dimensions of the mask are taken into consideration in the calculation of sagging, and/or the present position of the mask in the mask holder is determined prior to the calculation of sagging and is taken into consideration in the numerical calculation.

10. The method as claimed in claim 9, wherein the mask holder is provided as a 3-point support.

11. The method as claimed in claim 9, wherein the position of the mask in the mask holder is measured.

12. The method as claimed in claim 11, wherein at least the position of a mask edge relative to the mask holder is measured.

13. The method as claimed in claim 9, wherein the geometrical dimensions of the mask, which are taken into consideration in the calculation of sagging, are determined by measurements.

14. The method as claimed in claim 13, wherein the measurements of the geometrical dimensions of the mask are carried out on the mask positioned on the mask holder.

15. The method as claimed in claim 9, wherein the mask is provided substantially as a cuboid, and the measured length, width and height of the cuboid are taken into consideration in the calculation of sagging.

16. The method as claimed in claim 9, wherein the mask is provided substantially as a cuboid, and the weight of the mask and two of the cuboid's three dimensions of length, width and height are measured, and the third dimension is calculated on the basis of the two measured dimensions and of the measured weight.

17. The method as claimed in claim 9, wherein the mask is positioned in a predetermined position in order to determine the position of the mask in the mask holder.

18. The method as claimed in claim 17, wherein the positioning of the mask in the mask holder is carried out with feedback control.

19. The apparatus as claimed in claim 4, wherein the mask is provided substantially as a cuboid and the apparatus comprises a second measuring module, which measures the weight of the mask and two of the cuboid's three dimensions of length, width and height and calculates the third dimension on the basis of the two measured dimensions and of the measured weight.

20. The apparatus as claimed in claim 6, comprising a handling module, which positions the mask in a predetermined position in order to determine the position of the mask in the mask holder.
